(19) United States
(12) Patent Application Publication
(10) Pub. No.: US 2024/0234810 A9
(43) Pub. Date: Jul. 11, 2024

(54) CATHODE AND METHOD OF FORMING THE SAME

(71) Applicant: Medtronic, Inc., Minneapolis, MN (US)

(72) Inventor: Kaimin Chen, Shoreview, MN (US)

(21) Appl. No.: 17/970,014

(22) Filed: Oct. 20, 2022

(51) Int. Cl. H01M 10/0565; H01M 4/04; H01M 4/38; H01M 4/62; H01M 10/0568

(52) U.S. Cl. CPC H01M 10/0565; H01M 4/043; H01M 4/382; H01M 4/625; H01M 10/0568; H01M 2004/028

(57) ABSTRACT

An electrochemical cells and methods of forming the same are described. An electrochemical cell includes an anode, a cathode, a separator, and a liquid electrolyte. The cathode includes an active material, a conductive material, a binder, and a gelling electrolyte. The separator is arranged between the anode and the cathode. The separator is configured to prevent direct contact between the anode and the cathode. The liquid electrolyte transports ions between the cathode and the anode.

### FIELD

The present disclosure relates to, among other things, batteries and electrochemical cells.

### TECHNICAL BACKGROUND

Lithium batteries may include one or more electrochemical cells. Lithium batteries may include primary or rechargeable batteries. Each electrochemical cell includes an anode (e.g., a negative electrode), a cathode (e.g., a positive electrode), and an electrolyte provided within a case or housing. A separator made from a porous polymer or other suitable material may also be provided intermediate or between the anode and the cathode to prevent direct contact between the anode and the cathode. The anode includes a current collector having an active material, and the cathode includes a current collector having an active material.

Lithium batteries, or electrochemical cells, typically use liquid electrolyte to provide high conductivity and for its wettability on electrode surfaces. Low viscosity liquid electrolyte has relatively higher ionic conductivity that can provide a higher power output compared to other electrolyte compositions or higher viscosity liquid electrolytes. Additionally, low viscosity liquid electrolyte may be easier to dispense into the battery during battery assembly. However, interactions between low viscosity liquid electrolytes and typical lithium battery cathodes may provide some barriers to achieving a robust mechanical design of the battery while also providing high capacity and stable or smooth voltage curves during charge and discharge.

A sufficient quantity of electrolyte in close contact with active materials of the electrodes while the battery is charged or discharged, may provide a smooth voltage curve as the battery is charged or discharged and maintain the power capability of the battery over time. However, the electrodes of lithium batteries may expand or shrink while being charged or discharged. The cathode of lithium batteries may expand up to 50 percent to 100 percent during later stages of discharge. When the cathode expands, the porosity of the cathode increases. Voids may form within the cathode if electrolyte is unable to fill in the expanded pores of the cathode. Such voids may cause the voltage of the battery to fluctuate erratically and decrease the power capability and usable capacity of the battery.

Such effects can be mitigated by an increase in the amount of liquid electrolyte used to fill the battery and/or an increase in stack pressure between the cathode and the anode. Such increases may result, individually or in combination, in a smoother voltage curve and more robust power capabilities. However, as the amount of liquid electrolyte increases the ratio of active material of the battery decreases, which may result in a lower battery capacity or energy density. Furthermore, an increase in stack pressure may require a thicker and more rigid battery case that may reduce energy density and increase an overall cost of the battery.

Additionally, low viscosity liquid electrolyte may move within the battery enclosure more readily than higher viscosity electrolytes. Such movement may lead to the movement of lithium ions within the battery and cause uncontrolled lithium deposition on inner surfaces of the battery case or housing, and electrode terminals. Furthermore, such deposition may damage insulation between the anode and cathode. As a result, an increase in self-discharge of the battery may occur.

### BRIEF SUMMARY

As described herein, a smooth voltage curve of a lithium battery including liquid electrolyte may be achieved by including gelling powder with cathode materials and subsequently mixing liquid electrode with the cathode materials during cathode formation. The sequential addition of such gelling powder and liquid electrolyte to the cathode materials may allow gelled electrolyte to form throughout the cathode materials to provide a gelled cathode mixture prior to pressing or formation of the cathode. Accordingly, a more uniform cathode that includes or incorporates a gelled electrolyte may be provided. Additionally, such cathode may have a higher density, have fewer or less voluminous voids or air pockets, and may be easier to manufacture than cathodes formed using typical methods. Furthermore, less electrolyte may be used in electrochemical cells that include cathodes with gelled electrolyte and the free liquid electrolyte within the battery or electrochemical cell may be reduced.

In general, in one aspect, the present disclosure describes a method of forming an electrochemical cell. The method comprises grinding cathode materials to provide a cathode powder. The method further comprises mixing a gelling powder with the cathode powder to provide gelling cathode powder and mixing a liquid electrolyte with the gelling cathode powder to provide a gelled cathode mixture. Still further, the method may comprise pressing the gelled cathode mixture to form a cathode of the electrochemical cell.

In general, in another aspect, the present disclosure describes a method of forming an electrochemical cell. The method comprises mixing an active material, a conductive material, and a binder to provide a cathode slurry. The method further comprises heating the cathode slurry to provide a dried cathode mixture and grinding the dried cathode mixture to provide a cathode powder. The method further comprises mixing a gelling powder with the cathode powder to provide gelling cathode powder. The method further comprises mixing a liquid electrolyte with the gelling cathode powder to provide a gelled cathode mixture. Still further, the method may comprise pressing the gelled cathode mixture to form a cathode of the electrochemical cell.

In general, in another aspect, the present disclosure describes an electrochemical cell comprising an anode, a cathode, a separator, and a liquid electrolyte. The cathode has a porosity of less than 20 percent by volume. The cathode comprises an active material, a conductive material, a binder, and a gelled electrolyte. The separator is arranged between the anode and the cathode. The separator is configured to prevent direct contact between the anode and the cathode. The liquid electrolyte transports ions between the cathode and the anode.

Advantages and additional features of the subject matter of the present disclosure will be set forth in the detailed description which follows, and in part will be readily apparent to those skilled in the art from that description or recognized by practicing the subject matter of the present disclosure as described herein, including the detailed description which follows, the claims, as well as the appended drawings.

It is to be understood that both the foregoing general description and the following detailed description present embodiments of the subject matter of the present disclosure, and are intended to provide an overview or framework for understanding the nature and character of the subject matter of the present disclosure as it is claimed. The accompanying drawings are included to provide a further understanding of the subject matter of the present disclosure and are incorporated into and constitute a part of this specification. The drawings illustrate various embodiments of the subject matter of the present disclosure and together with the description serve to explain the principles and operations of the subject matter of the present disclosure. Additionally, the drawings and descriptions are meant to be merely illustrative and are not intended to limit the scope of the claims in any manner.

### BRIEF DESCRIPTION OF THE DRAWINGS

The following detailed description of specific embodiments of the present disclosure can be best understood when read in conjunction with the following drawings, in which:

FIG. 1 is a schematic block diagram of an embodiment of an electrochemical cell;

FIG. 2 is a schematic flow diagram of a method for forming the electrochemical cell of FIG. 1;

FIG. 3 is a schematic flow diagram of another method for forming the electrochemical cell of FIG. 1.

### DETAILED DESCRIPTION

Reference will now be made in greater detail to various embodiments of the subject matter of the present disclosure, some embodiments of which are illustrated in the accompanying drawings. Like numbers used in the figures refer to like components and steps. However, it will be understood that the use of a number to refer to a component in a given figure is not intended to limit the component in another figure labeled with the same number. In addition, the use of different numbers to refer to components in different figures is not intended to indicate that the different numbered components cannot be the same or similar to other numbered components.

Reduction in erratic voltage changes and lithium plating can be achieved by adding a liquid electrolyte to a gelling cathode powder to provide a gelled cathode mixture during cathode formation in lithium batteries or electrochemical cells that are assembled include a liquid electrolyte. Reduction of erratic voltage changes may result in a smooth voltage curve of a lithium battery. The gelled cathode mixture of the formed cathode may cause gelled electrolyte to be dispersed throughout the cathode including surfaces of the cathode. Accordingly, when the cathode expands, the gelled electrolyte may prevent or reduce void formation as the cathode expands during use. As a result, erratic voltage changes that may be caused by void formation may be eliminated or reduced. Thus, the voltage of the battery may change smoothly as the battery is charged or discharged. Additionally, increased resistance due to void formation may be reduced or eliminated. Accordingly, the ability of the battery to provide power in bursts or pulses may be uncompromised when the battery is charged or discharged.

Furthermore, less liquid electrolyte may be used to fill the cell housing of the electrochemical cell while still reducing void formation and, thereby, the energy density of the battery may be increased and free liquid electrolyte within the battery may be reduced. A reduction in free liquid electrolyte may reduce lithium deposition that can result in damage to insulation between the anode and cathode and cause an increase in self-discharge. Thus, the use of a gelled cathode mixture to form the cathode may reduce the likelihood of defects that result in increased self-discharge that can occur due to lithium deposition.

Still further, the gelled cathode mixture and cathodes formed from the gelled cathode mixture may have a more uniform composition than cathodes formed by mixing a gelled electrolyte with other cathode materials. Mixing gelled electrolyte with a ground dried cathode mixture or powdered cathode materials may result in a clumped cathode composition that is unsuitable for cathode formation or pressing. Furthermore, such mixing of gelled electrolyte with a ground dried cathode mixture may result in prolonged manufacturing processes and increased cost. In contrast, the gelled cathode mixture described herein may incorporate gelled electrolyte throughout the dried cathode mixture or materials and is suitable for cathode formation or pressing. Additionally, the cathode as described herein may be formed without the use of volatile solvents, often included in liquid electrolytes, to aid in mixing the cathode materials.

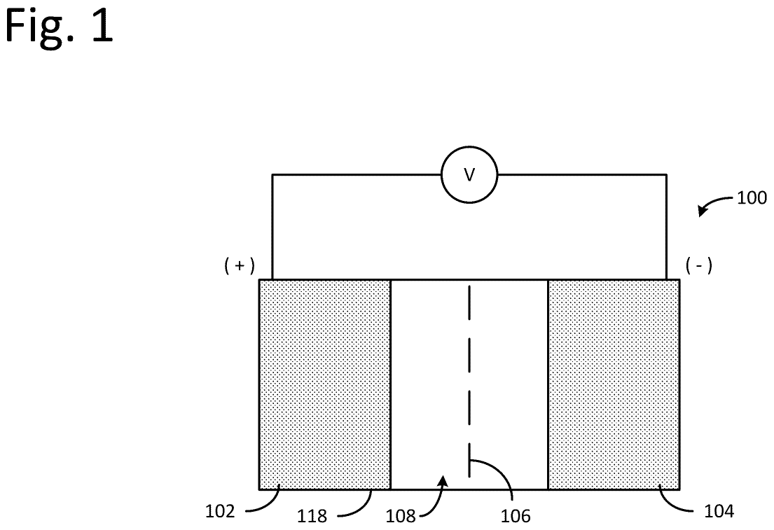

FIG. 1 shows a schematic representation of an electrochemical cell 100. The electrochemical cell 100 includes an anode 102 (e.g., a negative electrode), a cathode 104 (e.g., a positive electrode), a liquid electrolyte 108, and a separator 106 (e.g., a polymeric microporous separator, indicated by the dashed line).

The electrochemical cell 100 may include any suitable chemistry. The chemistry of the electrochemical cell 100 may include, for example, lithium-metal, lithium-ion, lithium polymer, or other chemistries that may be subject to cathode expansion issues. In at least one embodiment, the electrochemical cell 100 includes a lithium-ion battery cell. The electrochemical cell 100 may be a primary cell or a secondary cell. In other words, the electrochemical cell 100 may or may not be rechargeable.

The anode 102 may include any suitable material or materials. Such materials may include, for example, one or more active materials, conductive materials, binders, or other suitable anode materials. Active material of the anode 102 may include, for example, one or more of carbon, graphite, silicon, lithium titanates, lithium, sodium, magnesium, or other negative active. Conductive materials of the anode 102 may include, for example, copper, gold, carbon, nickel, carbon black, graphene, carbon nanotubes, or other conductive materials. Binders of the anode 102 may include, for example, polyvinylidene fluoride (PVDF), poly(vinylidene fluoride-co-hexafluoropropylene) (PVDF-HFP), styrene-butadiene rubber (SBR), carboxymethyl cellulose (CMC), or other materials for binding anode materials together.

The cathode 104 may include any suitable material or materials. Such materials may include, for example, one or more active materials, conductive materials, binders, gelled electrolyte, or other cathode materials. Active material of the cathode 104 may include, for example, carbon fluoride, silver vanadates, lithium vanadates, manganese dioxide, vanadium dioxide, lithium cobalt oxide, lithium nickel-manganese-cobalt oxide, lithium nickel-cobalt-aluminum oxide, or other positive active materials. In one or more embodiment, the active material of the cathode includes carbon fluoride and silver vanadium oxide. Conductive materials of the cathode 104 may include, for example, copper, gold, carbon, nickel, carbon black, graphene, carbon nanotubes, or other conductive materials. Binders of the cathode 104 may include, for example, polyvinylidene fluoride (PVDF), poly(vinylidene fluoride-co-hexafluoropropylene) (PVDF-HFP), styrene-butadiene rubber (SBR), carboxymethyl cellulose (CMC), poly(tetrafluoroethylene) (PTFE), or other material for binding cathode materials together.

The gelled electrolyte of the cathode 104 may include or be formed from a gelling powder and a liquid electrolyte. The gelling powder may include, for example, polyethylene oxide, polypropylene oxide, polyacrylonitrile, poly(methylmethacrylate), cellulose, or any other suitable gelling agent. The materials of the gelling powder of the cathode 104 may be ground or otherwise processed to provide particles fine enough to be mixed with other powdered cathode materials. The gelling powder of the cathode may be configured to cause liquid electrolyte added to the other cathode materials of the cathode 104 to gel or become the gelled electrolyte. The gelled electrolyte may be dispersed throughout the cathode and may prevent the formation of voids or pores as the cathode 104 expands during use of the electrochemical cell 100.

Additionally, the gelled electrolyte of the cathode 104 may allow for greater cathode densities than those of typical electrochemical cells. For example, the cathode 104 may have a porosity of less than 20 percent by volume. In other words, the ratio of the volume of interstices (e.g., intervening space, voids, etc.) of the cathode material to the volume of the cathode material mass is 1:4 or less. Further, for example, the cathode 104 may have a porosity of less than 15 percent by volume, 10 percent by volume, or 5 percent by volume. The cathode 104 may include any suitable amount of gelled electrolyte. In one or more embodiments, the cathode 104 may include 10 percent to 20 percent by weight gelled electrolyte.

The electrodes 102, 104 may be provided as relatively flat or planar plates or may be wrapped or wound in a spiral or other configuration (e.g., an oval configuration). The electrodes 102, 104 may also be provided in a folded configuration.

The separator 106 may be arranged between the anode 102 and the cathode 104. In other words, the separator 106 may be provided intermediate or between the anode 102 and the cathode 104. The separator 106 may be configured to prevent direct contact between the anode 102 and the cathode 104. The separator 106 may further be configured to allow transport of ionic charge carriers between the anode 102 and the cathode 104.

The separator 106 may take on any suitable size or shape. The separator 106 may be, for example, flat, planar, wrapped or wound in a spiral, elliptical, folded, or any other suitable shape for being arranged between the anode 102 and the cathode 104. In general, the size and shape of the separator 106 may be dependent on or conform to the size and shape of the electrodes 102, 104. For example, the separator 106 may be provided as relatively flat or planar when the electrodes 102, 104 are provided as planar plates. Further, for example, the separator 106 may be provided in a wound configuration to separate the electrodes 102, 104 when such electrodes are provided in a wound or spiral configuration.

The separator 106 may define a membrane forming a microporous layer. The separator 106 may include any suitable material or materials. The separator 106 may include, for example, one or more of a polymer, polyethylene, polypropylene, polyimide, cellulose, or other materials for forming a microporous layer.

The liquid electrolyte 108 may transport positively charged ions between the anode 102 and the cathode 104. The liquid electrolyte 108 may include any suitable material or materials. The liquid electrolyte 108 may include one or more solutes. Solutes of the liquid electrolyte 108 may include, for example, lithium salts, lithium bis(trifluoromethylsulfonyl) imide (LiTFSI), lithium bis(pentafluoroethylsulfonyl) imide (LiBETI), lithium tris(trifluorosulfonyl) methide, lithium perchlorate (LiClO₄), lithium tetrafluoroborate (LiBF₄), lithium hexafluoroarsenate (LiAsF₆), lithium hexafluorophosphate (LiPF₆), or other solute capable of transporting ionic charge carriers. The gelled electrolyte of the cathode 104 may allow the liquid electrolyte 108 to be provided without the use of volatile solvents. Typical solvents may include, for example, one or more of propylene carbonate, ethylene carbonate, dimethyl carbonate, dimethoxyethane, diethoxyethane, or other solvent. The liquid electrolyte 108 may be a low viscosity liquid electrolyte. As used herein, the term “low viscosity” refers to a viscosity of less than 50 centipoises. The viscosity of the liquid electrolyte 108 may less than 10 centipoises. The viscosity of the liquid electrolyte 108 may less than 5 centipoises. In one or more embodiments, a viscosity of the liquid electrolyte 108 is less than 2 centipoises. The electrochemical cell 100 may have an electrolyte weight to cathode weight ratio of 0.5 or less.

The electrochemical cell may further include a cell housing 118. The cell housing 118 of the electrochemical cell 100 may include any suitable resilient material or materials. Resilient (e.g., resistant to puncture and corrosion and chemically stable) material or materials may be configured to protect the internal components (e.g., the anode 102, the cathode 104, the separator 106, the liquid electrolyte 108, etc.) of the electrochemical cell 100. Such resilient materials may include, for example, nickel, steel, titanium, aluminum, or other resilient materials. Packaging may include any suitable packaging material or materials for holding internal components of the electrochemical cell 100 together in a predefined shape. Such packaging materials may include, plastic, ceramics, etc.

During charging and discharging of the electrochemical cell 100, lithium ions move between the anode 102 and the cathode 104. For example, when the electrochemical cell 100 is charged, lithium ions flow from the cathode 104 to the anode 102. In contrast, when the electrochemical cell 100 is discharged, lithium ions flow from the anode 102 to the cathode 104.

As the electrochemical cell 100 charges or discharges, the cathode 104 may expand. Typical cathodes generally include pores or voids that may expand as such cathode expands. However, in typical lithium batteries (or other battery chemistries), liquid electrolyte may not fill pores of a cathode as the cathode and pores expand and, as a result, voids may form in the pores of such cathodes. Voids are breaks in contact between the liquid electrolyte and the cathode that may diminish the effective area for ionic conduction between the liquid electrolyte and the cathode. Thus, such voids may result in erratic changes in voltage of the batteries and an increase in resistance of the electrochemical cell 100 as the cathode expands and ionic conduction between the liquid electrolyte and the cathode fluctuates. However, the cathode 104 of the electrochemical cell 100 includes a gelled electrolyte dispersed throughout the cathode 104.

The gelled electrolyte of cathode 104 may eliminate or reduce the occurrence of any pores or voids in the cathode 104. Additionally, the gelled electrolyte of the cathode 104 may also reduce or eliminate the expansion of any pores or voids that may be included in the cathode 104. The gelled electrolyte of cathode 104 may readily fill any pores or voids as they expand, preventing or reducing void formation and maintaining close contact for ionic conduction between the liquid electrolyte 108 and the cathode 104. Accordingly, erratic changes in voltage that may be caused by such voids are also prevented or reduced in electrochemical cell 100. Additionally, resistance increases that may be caused by void formation may be eliminated or reduced and a pulse power or capability of the electrochemical cell 100 may be maintained throughout cell charge or discharge.

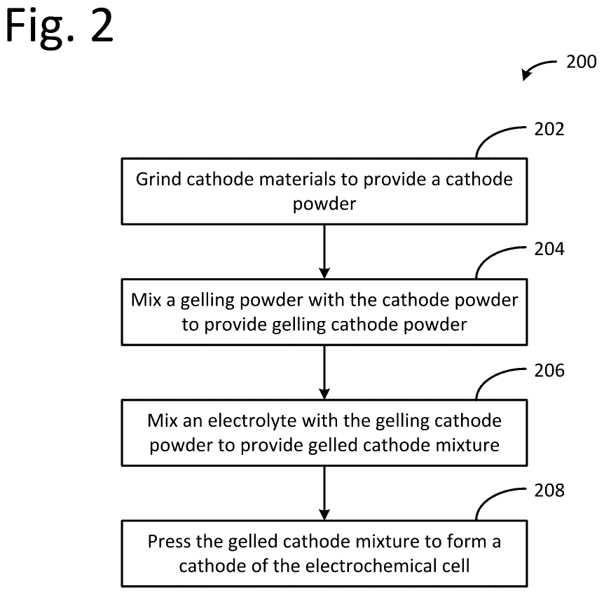

FIG. 2 shows a flow diagram of a method or process 200 for forming a battery or electrochemical cell (e.g., the electrochemical cell 100 of FIG. 1).

At 202, cathode materials may be ground to provide a cathode powder. Grinding the cathode materials may provide a relatively uniform particle size distribution in the cathode powder. The cathode powder may have a particle size distribution between about 0.1 microns to about 1000 microns. In one embodiment, the cathode powder has an average particle size distribution of at least 100 microns to no greater than 200 microns.

The cathode materials may include an active material, a conductive material, a binder. Providing the cathode materials, prior to grinding, may include mixing the cathode materials with a solvent to form or provide a cathode slurry. The cathode slurry may be provided without the use of volatile solvents. The active material, the conductive material, and the binder may be mixed using any suitable technique or techniques. Such techniques may include, for example, mixing using a planetary mixer, a rotary mixer, or a spiral mixer. Providing the cathode materials may also include heating the cathode slurry to provide a dried cathode mixture. In other words, the cathode materials may be provided as a dried cathode mixture. The cathode slurry may be heated to at least 100 degrees Celsius to no more than 200 degrees Celsius. Heating the cathode slurry may dry the cathode slurry. In other words, heating the cathode slurry may remove moisture that may be present in the cathode slurry.

At 204, the cathode materials may be ground to provide a cathode powder. Grinding the dried cathode mixture may provide a relatively uniform particle size distribution in the cathode powder. The cathode powder may have a particle size distribution between about 0.1 microns to about 1000 microns. In one embodiment, the cathode powder has an average particle size distribution of at least 100 microns to no greater than 200 microns. The cathode powder may optionally be heated. The cathode powder may be heated to at least 150 degrees Celsius to no more than 300 degrees Celsius. Heating the cathode powder may dry the cathode powder. In other words, heating the cathode powder may remove any residual moisture from the cathode powder.

At 206, a gelling powder may be mixed with the cathode powder to provide gelling cathode powder. Mixing the gelling powder with the cathode powder may provide a more uniform mixing of cathode materials and gelling powder than at other stages of cathode formation. For example, the gelling powder may absorb water or other moisture during previous steps. The gelling powder may be mixed with the cathode powder using any suitable technique or techniques. Such techniques may include, for example, the gelling powder may be mixed with the cathode powder using an acoustic mixer, a planetary mixer, a spiral mixer, or other mixing apparatus or techniques. The gelling cathode powder may include at least 0.1 percent by weight and no greater than 10 percent by weight of the gelling powder. The gelling cathode powder may include at least 1 percent by weight and no greater than 5 percent by weight of the gelling cathode powder. The gelling cathode powder may include at least 2 percent by weight and no greater than 4 percent by weight of the gelling powder.

At 208, the gelling cathode powder may be mixed with a liquid electrolyte to provide a gelled cathode mixture. The gelling cathode powder may be mixed with the liquid electrolyte using any suitable technique or techniques. Such techniques may include, for example, using an acoustic mixer, a planetary mixer, a spiral mixer, or other mixing apparatus or techniques to mix the gelling cathode powder with the liquid electrolyte. In one or more embodiments, mixing the liquid electrolyte with the gelling cathode powder includes mixing the liquid electrolyte with the gelling cathode powder using an acoustic mixer.

The method 200 may further include storing the gelled cathode mixture for a predetermined time period. Storing the gelled cathode mixture may allow the gelling powder and the liquid electrolyte to form the gelled electrolyte throughout the gelled cathode mixture. The predetermined time period may be at least 1 hour. In one or more embodiments, the predetermined time period may be at least 1 hour and no greater than 2 days, or any range of time therebetween. The gelled cathode mixture may be stored at room temperature or up to 100 degrees Celsius. For example, the gelled cathode mixture may be stored at a temperature of at least 20 degrees Celsius and no greater than 70 degrees Celsius.

At 214, the gelled cathode mixture may be pressed to form a cathode (e.g., cathode 104) of the electrochemical cell. The gelled cathode mixture may be pressed into a current collector cup, onto a current collector, or into a mold to form the cathode. The gelled cathode mixture may be subject to a pressure of about 1000 psi to about 100000 psi when pressed.

The method 200 may further include disposing a liquid electrolyte (e.g., liquid electrolyte 108) in a housing (e.g., cell housing 118) of the electrochemical cell to transport ions between an anode (e.g., anode 102) and the cathode of the electrochemical cell. Additionally, the method 200 may further include sealing the electrochemical cell.

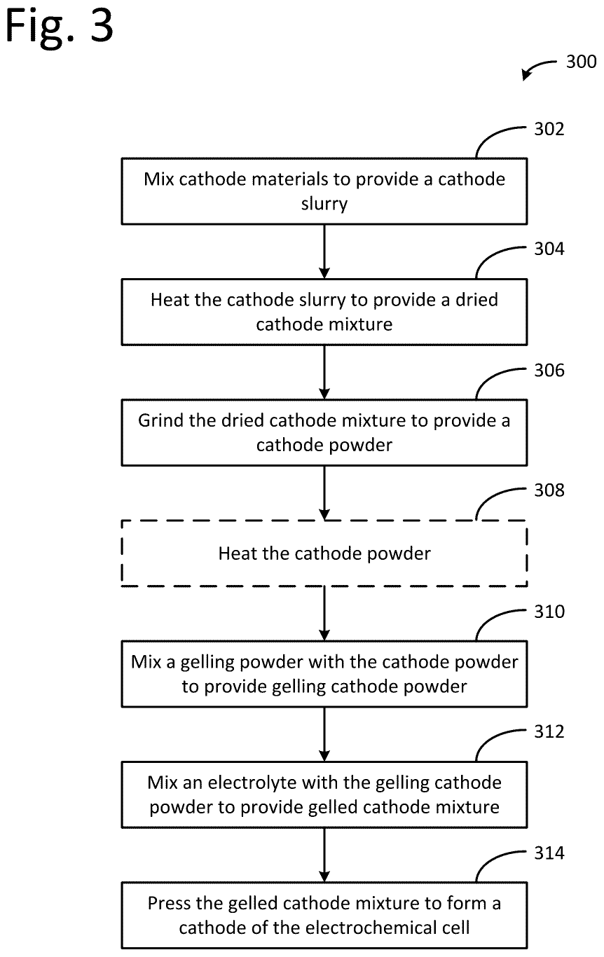

FIG. 3 shows a flow diagram of a method or process 300 for forming a battery or electrochemical cell (e.g., the electrochemical cell 100 of FIG. 1).

At 302, an active material, a conductive material, a binder, and a solvent may be mixed to provide a cathode slurry. The cathode slurry may be provided without the use of any solvents. The active material, the conductive material, and the binder may be mixed using any suitable technique or techniques. Such techniques may include, for example, mixing using a planetary mixer, a rotary mixer, or a spiral mixer.

At 304, the cathode slurry may be heated to provide a dried cathode mixture. The cathode slurry may be heated to at least 100 degrees Celsius to no more than 200 degrees Celsius. Heating the cathode slurry may dry the cathode slurry. In other words, heating the cathode slurry may remove moisture that may be present in the cathode slurry.

At 306, the dried cathode mixture may be ground to provide a cathode powder. Grinding the dried cathode mixture may provide a relatively uniform particle size distribution in the cathode powder. The cathode powder may have a particle size distribution between about 0.1 microns to about 1000 microns. In one embodiment, the cathode powder has an average particle size distribution of at least 100 microns to no greater than 200 microns.

At 308, the cathode powder may optionally be heated. The cathode powder may be heated to at least 150 degrees Celsius to no more than 300 degrees Celsius. Heating the cathode powder may dry the cathode powder. In other words, heating the cathode powder may remove any residual moisture from the cathode powder.

At 310, a gelling powder may be mixed with the cathode powder to provide gelling cathode powder. Mixing the gelling powder with the cathode powder may provide a more uniform mixing of cathode materials and gelling powder than at other stages of cathode formation. For example, the gelling powder may absorb water or other moisture during previous steps. The gelling powder may be mixed with the cathode powder using any suitable technique or techniques. Such techniques may include, for example, mixing the gelling powder with the cathode powder using an acoustic mixer, a planetary mixer, a spiral mixer, or other mixing apparatus or techniques. The gelling cathode powder may include at least 0.1 percent by weight and no greater than 10 percent by weight of the gelling powder. The gelling cathode powder may include at least 1 percent by weight and no greater than 5 percent by weight of the gelling cathode powder. The gelling cathode powder may include at least 2 percent by weight and no greater than 4 percent by weight of the gelling powder.

At 312, the gelling cathode powder may be mixed with a liquid electrolyte to provide a gelled cathode mixture. The gelling cathode powder may be mixed with the liquid electrolyte using any suitable technique or techniques. Such techniques may include, for example, mixing the gelling cathode powder with the liquid electrolyte using an acoustic mixer, a planetary mixer, a spiral mixer, or other mixing apparatus or techniques. In one or more embodiments, mixing the liquid electrolyte with the gelling cathode powder includes mixing the liquid electrolyte with the gelling cathode powder using an acoustic mixer.

The method 300 may further include storing the gelled cathode mixture for a predetermined time period. Storing the gelled cathode mixture may allow the gelling powder and the liquid electrolyte to form the gelled electrolyte throughout the gelled cathode mixture. The predetermined time period may be at least 1 hour. In one or more embodiments, the predetermined time period may be at least 1 hour and no greater than 2 days, or any range of time therebetween. The gelled cathode mixture may be stored at room temperature or up to 100 degrees Celsius. For example, the gelled cathode mixture may be stored at a temperature of at least 20 degrees Celsius and no greater than 70 degrees Celsius.

At 314, the gelled cathode mixture may be pressed to form a cathode (e.g., cathode 104) of the electrochemical cell. The gelled cathode mixture may be pressed into a current collector cup, onto a current collector, or into a mold to form the cathode. The gelled cathode mixture may be subject to a pressure of about 1000 psi to about 100000 psi when pressed.

The method 300 may further include disposing a liquid electrolyte (e.g., liquid electrolyte 108) in a housing (e.g., cell housing 118) of the electrochemical cell to transport ions between an anode (e.g., anode 102) and the cathode of the electrochemical cell. Additionally, the method 300 may further include sealing the electrochemical cell.

The invention is defined in the claims. However, below there is provided a non-exhaustive list of non-limiting examples. Any one or more of the features of these examples may be combined with any one or more features of another example, embodiment, or aspect described herein.

Example Ex1: A method of forming an electrochemical cell, the method comprising: mixing an active material, a conductive material, and a binder to provide a cathode slurry; heating the cathode slurry to provide a dried cathode mixture; grinding the dried cathode mixture to provide a cathode powder; mixing a gelling powder with the cathode powder to provide gelling cathode powder; mixing a liquid electrolyte with the gelling cathode powder to provide a gelled cathode mixture; and pressing the gelled cathode mixture to form a cathode of the electrochemical cell.

Example Ex2: The method as in example Ex1, further comprising storing the gelled cathode mixture for at least 1 hour.

Example Ex3: The method as in any one of the previous examples, further comprising storing the gelled cathode mixture for a predetermined time period at a temperature between 20 degrees Celsius and 100 degrees Celsius.

Example Ex4: The method as in any one of the previous examples, wherein mixing the liquid electrolyte with the gelling cathode powder comprises mixing the liquid electrolyte with the gelling cathode powder using an acoustic mixer.

Example Ex5: The method as in any one of the previous examples, wherein the gelling cathode powder comprises 2 percent by weight to 4 percent by weight of gelling powder.

Example Ex6: The method as in any one of the previous examples, wherein the gelling powder comprises polyethylene oxide.

Example Ex7: The method as in any one of the previous examples, wherein the conductive material comprises conductive carbon.

Example Ex8: The method as in any one of the previous examples, forming an anode of the electrochemical cell, the anode comprising lithium.

Example Ex9: The method as in any one of the previous examples, further comprising disposing a liquid electrolyte in a housing of the electrochemical cell to transport ions between an anode and the cathode of the electrochemical cell.

Example Ex10: The method as in any one of the previous examples, wherein the liquid electrolyte comprises a lithium salt solution.

Example Ex11: The method as in any one of the previous examples, wherein the liquid electrolyte comprises a viscosity less than 10 centipoise.

Example Ex12: The method as in any one of the previous examples, wherein the active material of the cathode comprises carbon fluoride and silver vanadium oxide.

Example Ex13: An electrochemical cell comprising: an anode; a cathode comprising a gelled cathode mixture, the gelled cathode mixture comprising: an active material; a conductive material; a binder; and a gelled electrolyte; a separator arranged between the anode and the cathode, the separator configured to prevent direct contact between the anode and the cathode; and a liquid electrolyte to transport ions between the cathode and the anode.

Example Ex14: The electrochemical cell as in example Ex13, wherein a porosity of the cathode is less than 20 percent by volume.

Example Ex15: The electrochemical cell as in any one of examples Ex13 or Ex14, wherein the cathode comprises 10 percent to 20 percent by weight gelled electrolyte.

Example Ex16: The electrochemical cell as in any one of examples Ex13 to Ex15, wherein the gelled electrolyte comprises polyethylene oxide.

Example Ex17: The electrochemical cell as in any one of examples Ex13 to Ex16, wherein the conductive material comprises conductive carbon.

Example Ex18: The electrochemical cell as in any one of examples Ex13 to Ex17, wherein the anode comprises lithium.

Example Ex19: The electrochemical cell as in any one of examples Ex13 to Ex18, wherein the electrolyte comprises a lithium salt solution.

Example Ex20: The electrochemical cell as in any one of examples Ex13 to Ex19, wherein the liquid electrolyte comprises a viscosity of less than 10 centipoise.

Example Ex21: The electrochemical cell as in any one of examples Ex13 to Ex20, wherein the electrochemical cell comprises an electrolyte weight to cathode weight ratio of 0.5 or less.

Example Ex22: The electrochemical cell as in any one of examples Ex13 to Ex21, wherein the active material of the cathode comprises carbon fluoride and silver vanadium oxide.

Example Ex23: A method of forming an electrochemical cell, the method comprising: grinding cathode materials to provide a cathode powder; mixing a gelling powder with the cathode powder to provide gelling cathode powder; mixing a liquid electrolyte with the gelling cathode powder to provide a gelled cathode mixture; and pressing the gelled cathode mixture to form a cathode of the electrochemical cell.

Example Ex24: The method as in example Ex23, further comprising storing the gelled cathode mixture for at least 1 hour.

Example Ex25: The method as in any one of examples Ex23 or Ex24, further comprising storing the gelled cathode mixture for a predetermined time period at a temperature between 20 degrees Celsius and 100 degrees Celsius.

Example Ex26: The method as in any one of examples Ex23 to Ex25, wherein mixing the liquid electrolyte with the gelling cathode powder comprises mixing the liquid electrolyte with the gelling cathode powder using an acoustic mixer.

Example Ex27: The method as in any one of examples Ex23 to Ex26, wherein the gelling cathode powder comprises 2 percent by weight to 4 percent by weight of gelling powder.

Example Ex28: The method as in any one of examples Ex23 to Ex27, wherein the gelling powder comprises polyethylene oxide.

Example Ex29: The method as in any one of examples Ex23 to Ex28, wherein the cathode material comprises an active material and a conductive material.

Example Ex30: The method as in any one of examples Ex23 to Ex29, forming an anode of the electrochemical cell, the anode comprising lithium.

Example Ex31: The method as in any one of examples Ex23 to Ex30, further comprising disposing a liquid electrolyte in a housing of the electrochemical cell to transport ions between an anode and the cathode of the electrochemical cell.

Example Ex32: The method as in example Ex31, wherein the liquid electrolyte comprises a lithium salt solution.

Example Ex33: The method as in any one of examples Ex31 or Ex32, wherein the liquid electrolyte comprises a viscosity less than 10 centipoise.

Example Ex34: The method as in any one of examples Ex23 to Ex33, wherein the active material of the cathode comprises carbon fluoride and silver vanadium oxide.

All scientific and technical terms used herein have meanings commonly used in the art unless otherwise specified. The definitions provided herein are to facilitate understanding of certain terms used frequently herein and are not meant to limit the scope of the present disclosure.

As used herein, singular forms “a,” “an” and “the” include plural referents unless the context clearly dictates otherwise. As used in this specification and the appended claims, the term “or” is generally employed in its sense including “and/or” unless the content clearly dictates otherwise. The term “and/or” means one or all of the listed elements or a combination of any two or more of the listed elements.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred. Any recited single or multiple feature or aspect in any one claim can be combined or permuted with any other recited feature or aspect in any other claim or claims.

It will be apparent to those skilled in the art that various modifications and variations can be made to the present inventive technology without departing from the spirit and scope of the disclosure. Since modifications, combinations, sub-combinations and variations of the disclosed embodiments incorporating the spirit and substance of the inventive technology may occur to persons skilled in the art, the inventive technology should be construed to include everything within the scope of the appended claims and their equivalents.

What is claimed is:

1. A method of forming an electrochemical cell, the method comprising:
grinding cathode materials to provide a cathode powder;
mixing a gelling powder with the cathode powder to provide gelling cathode powder;
mixing a liquid electrolyte with the gelling cathode powder to provide a gelled cathode mixture; and
pressing the gelled cathode mixture to form a cathode of the electrochemical cell.

2. The method as in claim 1, further comprising storing the gelled cathode mixture for at least 1 hour.

3. The method as in claim 1, further comprising storing the gelled cathode mixture for a predetermined time period at a temperature between 20 degrees Celsius and 100 degrees Celsius.

4. The method as in claim 1, wherein mixing the liquid electrolyte with the gelling cathode powder comprises mixing the liquid electrolyte with the gelling cathode powder using an acoustic mixer.

5. The method as in claim 1, wherein the gelling cathode powder comprises 2 percent by weight to 4 percent by weight of gelling powder.

6. The method as in claim 1, wherein the gelling powder comprises polyethylene oxide.

7. The method as in claim 1, wherein the cathode material comprises an active material and a conductive material.

8. The method as in claim 1, forming an anode of the electrochemical cell, the anode comprising lithium.

9. The method as in claim 1, further comprising disposing a liquid electrolyte in a housing of the electrochemical cell to transport ions between an anode and the cathode of the electrochemical cell.

10. The method as in claim 9, wherein the liquid electrolyte comprises a lithium salt solution.

11. The method as in claim 9, wherein the liquid electrolyte comprises a viscosity less than 10 centipoise.

12. An electrochemical cell comprising:
an anode;
a cathode comprising a gelled cathode mixture, the gelled cathode mixture comprising:
an active material;
a conductive material;
a binder; and
a gelled electrolyte;
a separator arranged between the anode and the cathode, the separator configured to prevent direct contact between the anode and the cathode; and
a liquid electrolyte to transport ions between the cathode and the anode.

13. The electrochemical cell as in claim 12, wherein a porosity of the cathode is less than 20 percent by volume.

14. The electrochemical cell as in claim 12, wherein the cathode comprises 10 percent to 20 percent by weight gelled electrolyte.

15. The electrochemical cell as in claim 12, wherein the gelled electrolyte comprises polyethylene oxide.

16. The electrochemical cell as in claim 12, wherein the conductive material comprises conductive carbon.

17. The electrochemical cell as in claim 12, wherein the anode comprises lithium.

18. The electrochemical cell as in claim 12, wherein the electrolyte comprises a lithium salt solution.

19. The electrochemical cell as in claim 12, wherein the liquid electrolyte comprises a viscosity of less than 10 centipoise.

20. The electrochemical cell as in claim 12, wherein the electrochemical cell comprises an electrolyte weight to cathode weight ratio of 0.5 or less.
